(19) United States
(12) Patent Application Publication
(10) Pub. No.: US 2013/0248691 A1
(43) Pub. Date: Sep. 26, 2013

(54) Methods and Systems for Sensing Ambient Light

(71) Applicants: Russell Norman Mirov, Los Altos, CA (US); Michael Kubba, Mountain View, CA (US)

(72) Inventors: Russell Norman Mirov, Los Altos, CA (US); Michael Kubba, Mountain View, CA (US)

(73) Assignee: GOOGLE INC., Mountain View, CA (US)

(21) Appl. No.: 13/428,311

(22) Filed: Mar. 23, 2012

(51) Int. Cl. G01J 1/44

(52) U.S. Cl. 250/214 AL

(57) ABSTRACT

Disclosed methods and systems relate to sensing ambient light. Some disclosed implementations operate in connection with a wearable computing device, such as a head-mountable display.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a very small image display element close enough to a wearer's eye(s) such that the displayed image fills or nearly fills the field of view, and appears as a normal sized image, such as might be displayed on a traditional image display device. The relevant technology may be referred to as “near-eye displays.”

Near-eye displays are fundamental components of wearable displays, also sometimes called head-mountable displays (HMDs). A HMD places a graphic display or displays close to one or both eyes of a wearer. To generate the images on a display, a computer processing system can be used. Such displays can occupy a wearer's entire field of view, or only occupy part of the wearer's field of view. Further, HMDs can be as small as a pair of glasses or as large as a helmet.

### SUMMARY

In some implementations, a computer-implemented method is provided. The method comprises, when a display of a head-mountable display (HMD) is in a low-power state of operation, receiving an indication to activate the display. The method comprises, in response to receiving the indication and before activating the display, obtaining a signal from an ambient light sensor that is associated with the HMD. The signal is indicative of ambient light at or near a time of receiving the indication. The method comprises, in response to receiving the indication, determining a display-intensity value based on the signal. The method comprises causing the display to switch from the low-power state of operation to a high-power state of operation. An intensity of the display upon switching is based on the display-intensity value.

In some implementations, a system is provided. The system comprises a non-transitory computer-readable medium and program instructions stored on the non-transitory computer-readable medium. The program instructions are executable by at least one processor to perform a method such as, for example, the computer-implemented method.

In some implementations, a computing device is provided. The computing device comprises a light guide. The light guide is disposed in a housing of the computing device. The light guide has a substantially transparent top portion. The light guide is configured to receive ambient light through the top portion. The light guide is further configured to direct a first portion of the ambient light along a first path toward an optical device disposed at a first location. The light guide is further configured to direct a second portion of the ambient light along a second path toward a light sensor disposed at a second location. The computing device comprises the light sensor. The light sensor is configured to sense the second portion of the ambient light and to generate information that is indicative of the second portion of the ambient light. The computing device comprises a controller. The controller is configured to control an intensity of the display based on the information.

In some implementations, a method is provided. The method comprises receiving ambient light at a contiguous optical opening of a housing of a computing device. The method comprises directing a first portion of the ambient light through a first aperture toward a first location in the housing. An optical device is disposed at the first location. The method comprises directing a second portion of the ambient light through a second aperture toward a second location in the housing. A light sensor is disposed at the second location. The method comprises sensing the second portion of the ambient light at the light sensor to generate information that is indicative of the second portion of the ambient light. The method comprises controlling an intensity of a display of the computing device based on the information.

### BRIEF DESCRIPTION OF THE FIGURES

FIGS. 1A-1D show examples of wearable computing devices.

FIG. 2 shows an example of a computing device.

FIG. 3 shows an example of a method for using sensed ambient light to activate a display.

FIGS. 4A-4C show a portion of a wearable device according to a first embodiment.

FIGS. 5A-5C show a portion of a wearable device according to a second embodiment.

FIGS. 6A-6C show a portion of a wearable device according to a third embodiment.

FIG. 7 shows an example of a method for sensing ambient light.

### DETAILED DESCRIPTION

### General Overview

Some head-mountable displays (HMDs) and other types of wearable computing devices have incorporated ambient light sensors. The ambient light sensor can be used to sense ambient light in an environment of the HMD. In particular, the ambient light sensor can generate information that is indicates, for example, an amount of the ambient light. A controller can use the information to adjust an intensity of a display of the HMD. In some situations, when activating a display of an HMD, it can be undesirable to use sensor information from when the display was last activated. For example, when an HMD's display is activated in a relatively bright ambient setting, a controller of the HMD can control the display at a relatively high intensity to compensate for the relatively high amount of ambient light. In this example, assume that the HMD is deactivated and then reactivated in a dark setting. Also assume that upon reactivation, the controller uses the ambient light information from the display's prior activation. Accordingly, the controller may activate the display at the relatively high intensity. This can result in a momentary flash of the display that a user of the HMD can find undesirable.

This disclosure provides examples of methods and systems for using sensed ambient light to activate a display. In an example of a method, when a display of an HMD is in a low-power state of operation, a controller can receive an indication to activate the display. In response, before activating the display, the controller obtains a signal from an ambient light sensor of the HMD. The signal is indicative of ambient light at or near a time of receiving the indication. The signal from the ambient light sensor can be generated before the display is activated, while the display is being activated, or after the display is activated. The controller determines a display-intensity value based on the signal. The controller causes the display to activate at an intensity that is based on the display-intensity value. In this way, undesirable momentary flashes can be prevented from occurring upon activation of the display.

In addition, some conventional computing devices have incorporated ambient light sensors. These computing devices can be provided with an optical opening that can enable ambient light to reach the ambient light sensor. In these conventional computing devices, the optical opening can be used solely to provide ambient light to the ambient light sensor.

This disclosure provides examples of methods and computing devices for sensing ambient light. In an example of a method, ambient light is received at a contiguous optical opening of a housing of a computing device. A first portion of the ambient light is directed through a first aperture toward a first location in the housing. An optical device is disposed at the first location. The optical device can include, for example, a camera, a flash device, or a color sensor, among others. A second portion of the ambient light is directed through a second aperture toward a second location in the housing. A light sensor is disposed at the second location. The light sensor senses the second portion of the ambient light to generate information that is indicative of the second portion of the ambient light. A controller can control an intensity of a display of the computing device based on the information. In this way, ambient light can be directed toward an optical device and a light sensor by way of a single contiguous optical opening.

### Example of a Wearable Computing Device

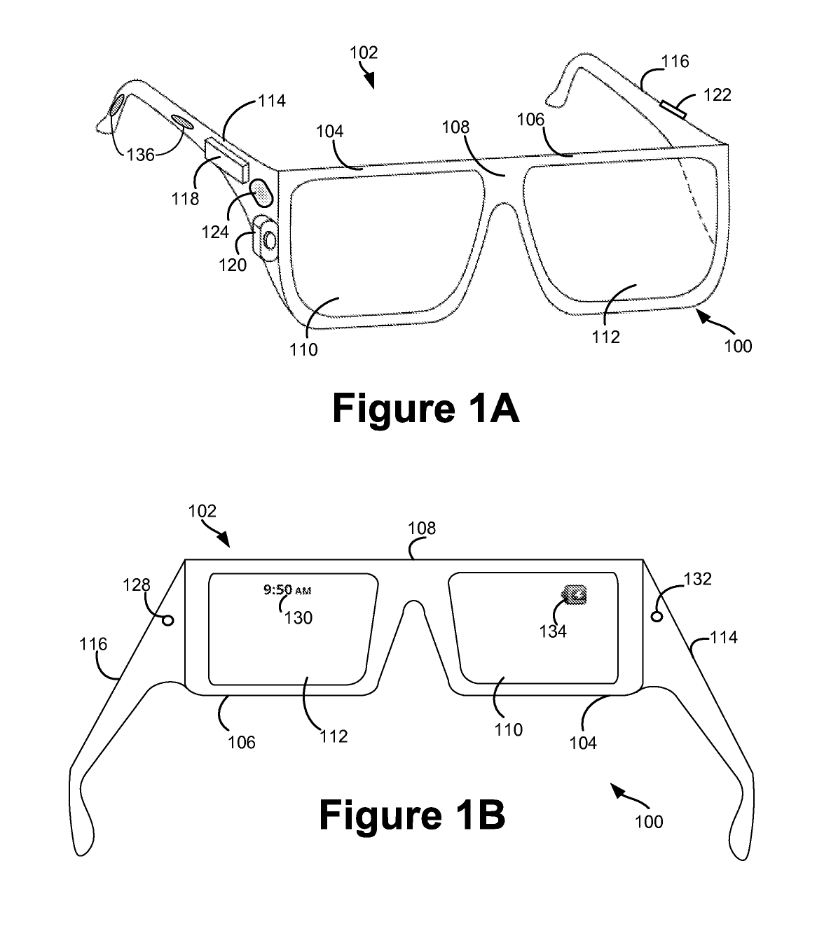

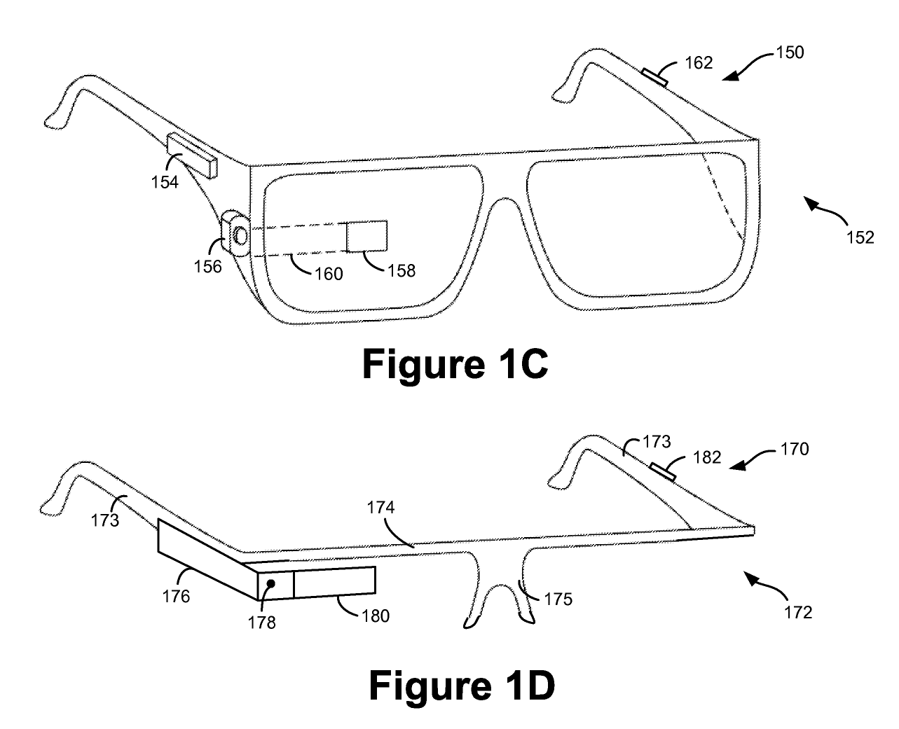

FIG. 1A illustrates an example of a wearable computing device 100. While FIG. 1A illustrates a head-mountable display (HMD) 102 as an example of a wearable computing device, other types of wearable computing devices can additionally or alternatively be used. As illustrated in FIG. 1A, the HMD 102 includes frame elements. The frame elements include lens-frames 104, 106, a center frame support 108, lens elements 110, 112, and extending side-arms 114, 116. The center support frame 108 and the extending side-arms 114, 116 are configured to secure the HMD 102 to a user's face via a user's nose and ears.

Each of the frame elements 104, 106, 108 and the extending side-arms 114, 116 can be formed of a solid structure of plastic, metal, or both, or can be formed of a hollow structure of similar material to allow wiring and component interconnects to be internally routed through the HMD 102. Other materials can be used as well.

The extending side-arms 114, 116 can extend away from the lens-frames 104, 106, respectively, and can be positioned behind a user's ears to secure the HMD 102 to the user. The extending side-arms 114, 116 can further secure the HMD 102 to the user by extending around a rear portion of the user's head. The HMD 102 can be affixed to a head-mounted helmet structure.

The HMD can include a video camera 120. The video camera 120 is shown positioned on the extending side-arm 114 of the HMD 102; however, the video camera 120 can be provided on other parts of the HMD 102. The video camera 120 can be configured to capture images at various resolutions or at different frame rates. Although FIG. 1A shows a single video camera 120, the HMD 102 can include several small form-factor video cameras, such as those used in cell phones or webcams.

Further, the video camera 120 can be configured to capture the same view or different views. For example, the video camera 120 can be forward-facing (as illustrated in FIG. 1A) to capture an image or video depicting a real-world view perceived by the user. The image or video can then be used to generate an augmented reality in which computer-generated images appear to interact with the real-world view perceived by the user. In addition, the HMD 102 can include an inward-facing camera. For example, the HMD 102 can include an inward-facing camera that can track the user's eye movements.

The HMD can include a finger-operable touch pad 124. The finger-operable touch pad 124 is shown on the extending side-arm 114 of the HMD 102. However, the finger-operable touch pad 124 can be positioned on other parts of the HMD 102. Also, more than one finger-operable touch pad can be present on the HMD 102. The finger-operable touch pad 124 can allow a user to input commands. The finger-operable touch pad 124 can sense a position or movement of a finger via capacitive sensing, resistance sensing, a surface acoustic wave process, or combinations of these and other techniques. The finger-operable touch pad 124 can be capable of sensing finger movement in a direction parallel or planar to a pad surface of the touch pad 124, in a direction normal to the pad surface, or both. The finger-operable touch pad can be capable of sensing a level of pressure applied to the pad surface. The finger-operable touch pad 124 can be formed of one or more translucent or transparent layers, which can be insulating or conducting layers. Edges of the finger-operable touch pad 124 can be formed to have a raised, indented, or roughened surface, to provide tactile feedback to a user when the user's finger reaches the edge of the finger-operable touch pad 124. If more than one finger-operable touch pad is present, each finger-operable touch pad can be operated independently, and can provide a different function.

The HMD 102 can include an on-board computing system 118. The on-board computing system 118 is shown to be positioned on the extending side-arm 114 of the HMD 102; however, the on-board computing system 118 can be provided on other parts of the HMD 102 or can be positioned remotely from the HMD 102. For example, the on-board computing system 118 can be connected by wire or wirelessly to the HMD 102. The on-board computing system 118 can include a processor and memory. The on-board computing system 118 can be configured to receive and analyze data from the video camera 120, from the finger-operable touch pad 124, and from other sensory devices and user interfaces. The on-board computing system 118 can be configured to generate images for output by the lens elements 110, 112.

The HMD 102 can include an ambient light sensor 122. The ambient light sensor 122 is shown on the extending side-arm 116 of the HMD 102; however, the ambient light sensor 122 can be positioned on other parts of the HMD 102. In addition, the ambient light sensor 122 can be disposed in a frame of the HMD 102 or in another part of the HMD 102, as will be discussed in more detail below. The ambient light sensor 122 can sense ambient light in the environment of the HMD 102. The ambient light sensor 122 can generate signals that are indicative of the ambient light. For example, the generated signals can indicate an amount of ambient light in the environment of the HMD 102.

The HMD 102 can include other types of sensors. For example, the HMD 102 can include a location sensor, a gyroscope, and/or an accelerometer, among others. These examples are merely illustrative, and the HMD 102 can include any other type of sensor or combination of sensors, and can perform any suitable sensing function.

The lens elements 110, 112 can be formed of any material or combination of materials that can suitably display a projected image or graphic (or simply “projection”). The lens elements 110, 112 can also be sufficiently transparent to allow a user to see through the lens elements 110, 112. Combining these features of the lens elements 110, 112 can facilitate an augmented reality or heads-up display, in which a projected image or graphic is superimposed over a real-world view as perceived by the user through the lens elements 110, 112.

FIG. 1B illustrates an alternate view of the HMD 102 illustrated in FIG. 1A. As shown in FIG. 1B, the lens elements 110, 112 can function as display elements. The HMD 102 can include a first projector 128 coupled to an inside surface of the extending side-arm 116 and configured to project a projection 130 onto an inside surface of the lens element 112. A second projector 132 can be coupled to an inside surface of the extending side-arm 114 and can be configured to project a projection 134 onto an inside surface of the lens element 110.

The lens elements 110, 112 can function as a combiner in a light projection system and can include a coating that reflects the light projected onto them from the projectors 128, 132. In some implementations, a reflective coating may not be used, for example, when the projectors 128, 132 are scanning laser devices.

The lens elements 110, 112 can be configured to display a projection at a given intensity in a range of intensities. In addition, the lens elements 110, 112 can be configured to display a projection at the given intensity based on an ambient setting in which the HMD 102 is located. In some ambient settings, displaying a projection at a low intensity can be suitable. For example, in a relatively dark ambient setting, such as a dark room, a high-intensity display can be too bright for a user. Accordingly, displaying the projected image at the low intensity can be suitable in this situation, among others. On the other hand, in a relatively bright ambient setting, it can be suitable for the lens elements 110, 112 to display a projection at a high intensity in order to compensate for the amount of ambient light in the environment of the HMD 102.

Similarly, the projectors 128, 132 can be configured to project a projection at a given intensity in a range of intensities. In addition, the projectors 128, 132 can be configured to project a projection at the given intensity based on an ambient setting in which the HMD 102 is located.

Other types of display elements can also be used. For example, the lens elements 110, 112 can include a transparent or semi-transparent matrix display, such as an electroluminescent display or a liquid crystal display. As another example, the HMD 102 can include waveguides for delivering an image to the user's eyes or to other optical elements capable of delivering an in focus near-to-eye image to the user. Further, a corresponding display driver can be disposed within the frame elements 104, 106 for driving such a matrix display. As yet another example, a laser or light emitting diode (LED) source and a scanning system can be used to draw a raster display directly onto the retina of one or more of the user's eyes. These examples are merely illustrative, and other display elements and techniques can be used as well.

FIG. 1C illustrates another example of a wearable computing device 150. While FIG. 1C illustrates a HMD 152 as an example of a wearable computing device, other types of wearable computing devices can be used. The HMD 152 can include frame elements and side-arms, such as those described above in connection with FIGS. 1A and 1B. The HMD 152 can include an on-board computing system 154 and a video camera 156, such as those described in connection with FIGS. 1A and 1B. The video camera 156 is shown mounted on a frame of the HMD 152; however, the video camera 156 can be mounted at other positions as well.

As shown in FIG. 1C, the HMD 152 can include a single display 158, which can be coupled to the HMD 152. The display 158 can be formed on one of the lens elements of the HMD 152, such as a lens element described in connection with FIGS. 1A and 1B. The display 158 can be configured to overlay computer-generated graphics in the user's view of the physical world. The display 158 is shown to be provided at a center of a lens of the HMD 152; however, the display 158 can be provided at other positions. The display 158 is controllable via the on-board computing system 154 that is coupled to the display 158 via an optical waveguide 160.

The HMD 152 can include an ambient light sensor 162. The ambient light sensor 162 is shown on an arm of the HMD 152; however, the ambient light sensor 162 can be positioned on other parts of the HMD 152. In addition, the ambient light sensor 162 can be disposed in a frame of the HMD 152 or in another part of the HMD 152, as will be discussed in more detail below. The ambient light sensor 162 can sense ambient light in the environment of the HMD 152. The ambient light sensor 162 can generate signals that are indicative of the ambient light. For example, the generated signals can indicate an amount of ambient light in the environment of the HMD 152.

The HMD 152 can include other types of sensors. For example, the HMD 152 can include a location sensor, a gyroscope, and/or an accelerometer, among others. These examples are merely illustrative, and the HMD 152 can include any other type of sensor or combination of sensors, and can perform any suitable sensing function.

FIG. 1D illustrates another example of a wearable computing device 170. While FIG. 1D illustrates a HMD 172 as an example of a wearable computing device, other types of wearable computing devices can be used. The HMD 172 can include side-arms 173, a center support frame 174, and a bridge portion with nosepiece 175. The center support frame 174 connects the side-arms 173. As shown in FIG. 1D, the HMD 172 does not include lens-frames containing lens elements. The HMD 172 can include an on-board computing system 176 and a video camera 178, such as those described in connection with FIGS. 1A-1C.

The HMD 172 can include a single lens element 180, which can be coupled to one of the side-arms 173 or to the center support frame 174. The lens element 180 can include a display, such as the display described in connection with FIGS. 1A and 1B, and can be configured to overlay computer-generated graphics upon the user's view of the physical world. As an example, the lens element 180 can be coupled to the inner side (for example, the side exposed to a portion of a user's head when worn by the user) of the extending side-arm 173. The lens element 180 can be positioned in front of (or proximate to) a user's eye when the HMD 172 is worn by the user. For example, as shown in FIG. 1D, the lens element 180 can be positioned below the center support frame 174.

The HMD 172 can include an ambient light sensor 182. The ambient light sensor 182 is shown on an arm of the HMD 172; however, the ambient light sensor 182 can be positioned on other parts of the HMD 172. In addition, the ambient light sensor 182 can be disposed in a frame of the HMD 172 or in another part of the HMD 172, as will be discussed in more detail below. The ambient light sensor 182 can sense ambient light in the environment of the HMD 172. The ambient light sensor 182 can generate signals that are indicative of the ambient light. For example, the generated signals can indicate an amount of ambient light in the environment of the HMD 172.

The HMD 172 can include other types of sensors. For example, the HMD 172 can include a location sensor, a gyroscope, and/or an accelerometer, among others. These examples are merely illustrative, and the HMD 172 can include any other type of sensor or combination of sensors, and can perform any suitable sensing function.

### Example of a Computing Device

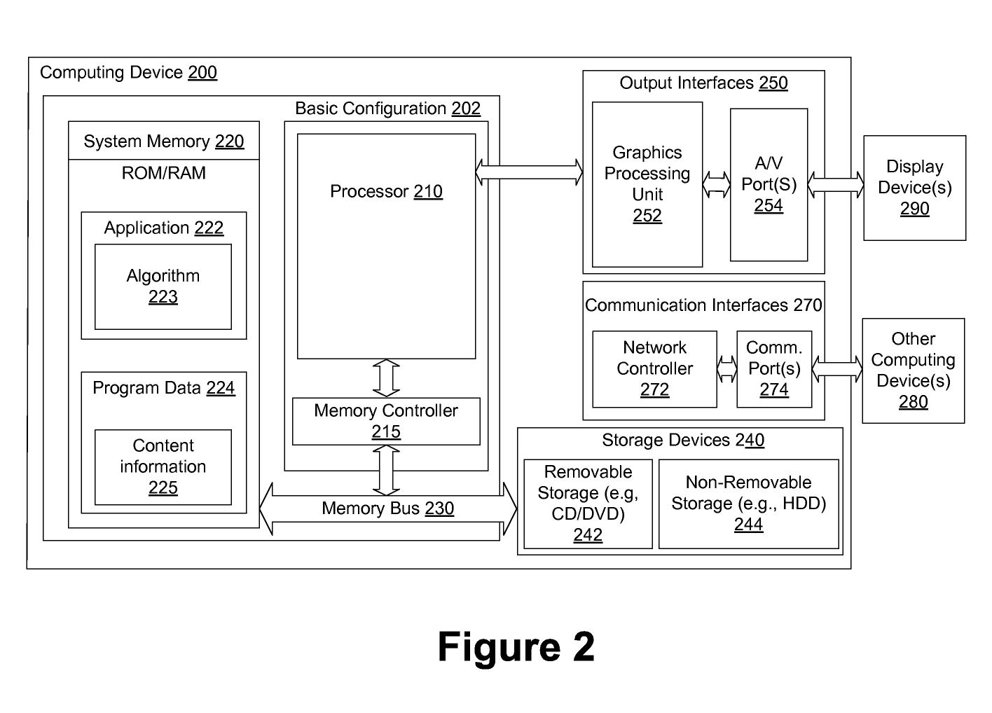

FIG. 2 illustrates a functional block diagram of an example of a computing device 200. The computing device 200 can be, for example, the on-board computing system 118 (shown in FIG. 1A), the on-board computing system 154 (shown in FIG. 1C), or another computing system or device.

The computing device 200 can be, for example, a personal computer, mobile device, cellular phone, touch-sensitive wristwatch, tablet computer, video game system, or global positioning system, among other types of computing devices. In a basic configuration 202, the computing device 200 can include one or more processors 210 and system memory 220. A memory bus 230 can be used for communicating between the processor 210 and the system memory 220. Depending on the desired configuration, the processor 210 can be of any type, including a microprocessor (μP), a microcontroller (μC), or a digital signal processor (DSP), among others. A memory controller 215 can also be used with the processor 210, or in some implementations, the memory controller 215 can be an internal part of the processor 210.

Depending on the desired configuration, the system memory 220 can be of any type, including volatile memory (such as RAM) and non-volatile memory (such as ROM, flash memory). The system memory 220 can include one or more applications 222 and program data 224. The application(s) 222 can include an algorithm 223 that is arranged to provide inputs to the electronic circuits. The program data 224 can include content information 225 that can be directed to any number of types of data. The application 222 can be arranged to operate with the program data 224 on an operating system.

The computing device 200 can have additional features or functionality, and additional interfaces to facilitate communication between the basic configuration 202 and any devices and interfaces. For example, data storage devices 240 can be provided including removable storage devices 242, non-removable storage devices 244, or both. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives. Computer storage media can include volatile and nonvolatile, non-transitory, removable and non-removable media implemented in any method or technology for storage of information, such as computer readable instructions, data structures, program modules, or other data.

The system memory 220 and the storage devices 240 are examples of computer storage media. Computer storage media includes, but is not limited to, RAM, ROM, EEPROM, flash memory or other memory technology, CD-ROM, DVDs or other optical storage, magnetic cassettes, magnetic tape, magnetic disk storage or other magnetic storage devices, or any other medium that can be used to store the desired information and that can be accessed by the computing device 200.

The computing device 200 can also include output interfaces 250 that can include a graphics processing unit 252, which can be configured to communicate with various external devices, such as display devices 290 or speakers by way of one or more A/V ports or a communication interface 270. The communication interface 270 can include a network controller 272, which can be arranged to facilitate communication with one or more other computing devices 280 over a network communication by way of one or more communication ports 274. The communication connection is one example of a communication media. Communication media can be embodied by computer-readable instructions, data structures, program modules, or other data in a modulated data signal, such as a carrier wave or other transport mechanism, and includes any information delivery media. A modulated data signal can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR), and other wireless media.

The computing device 200 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 200 can also be implemented as a personal computer including both laptop computer and non-laptop computer configurations.

### Example of a Method for Using Sensed Ambient Light to Activate a Display

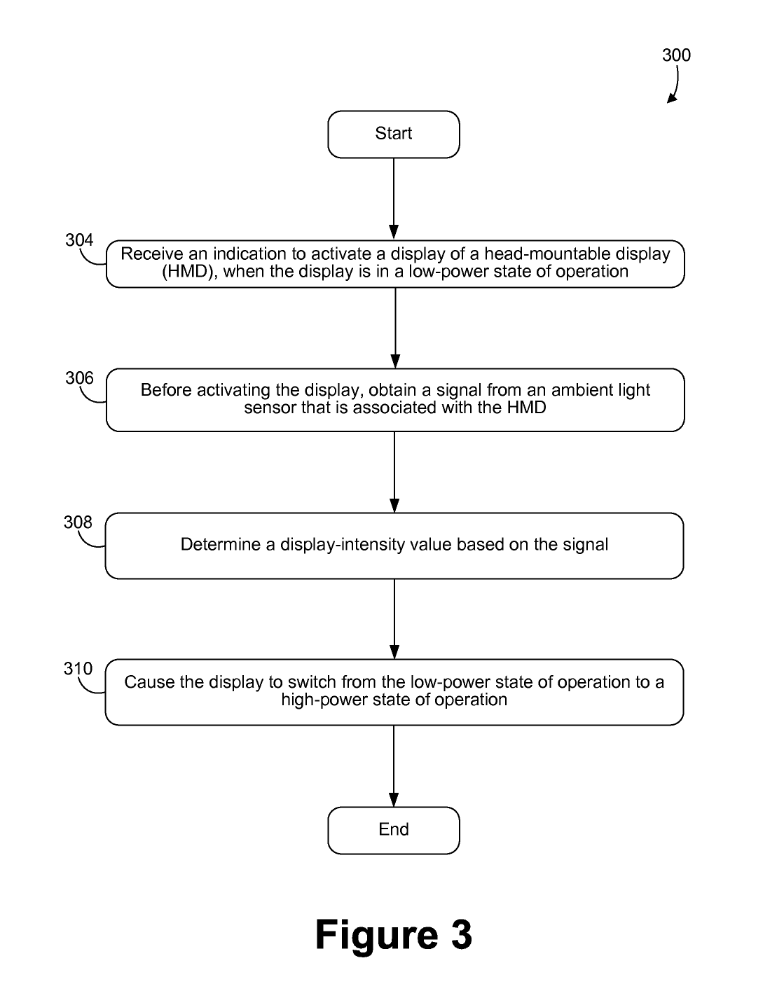

FIG. 3 illustrates an example of a method 300 for using sensed ambient light to activate a display. The method 300 can be performed, for example, in connection with any of the head-mountable displays (HMDs) 102, 152, 172 shown in FIGS. 1A-1D. In addition, the method 300 can be performed, for example, in connection with the computing device 200 shown in FIG. 2. The method 300 can be performed in connection with another HMD, wearable computing device, or computing device.

At block 304, the method 300 includes receiving an indication to activate a display of a HMD when the display is in a low-power state of operation. For example, with reference to the HMD 102 shown in FIGS. 1A and 1B, the on-board computing system 118 can receive an indication indicating that the on-board computing system 118 is to activate one or more display-related devices or systems. As an example, the indication can indicate that the on-board computing system 118 is to activate one or both of the lens elements 110, 112. As another example, the indication can indicate that the on-board computing system 118 is to activate one or both of the projectors 128, 132. Of course, the indication can indicate that the on-board computing system 118 is to activate some combination of the lens elements 110, 112 and the projectors 128, 132. The indication can also indicate that the on-board computing system 118 is to activate another display-related device or system.

Activating a display can depend at least in part on an HMD's configuration and/or present mode of operation. In addition, activating a display can include switching the display from a low-power state of operation to a high-power state of operation. For example, if a display of an HMD is switched off, then in some configurations, activating the display can include switching on the display. The display can be switched on, for example, in response to user input, in response to sensor input, or in another way, depending on the configuration of the HMD. In this example, the display is said to be in a low-power state of operation when the display is off, and is said to be in a high-power state of operation when the display is on. As another example, if an HMD is turned off, then in some configurations, activating the display can include switching on the HMD. In this example, the display is said to be in a low-power state of operation when the HMD is off, and is said to be in a high-power state of operation when the HMD is on. As another example, if a display of an HMD or the HMD itself operates in an idle mode, then activating the display can include switching the display or the HMD from the idle mode to an active mode. In this example, the display is said to be in a low-power state of operation when the display functions in the idle mode, and is said to be in a high-power state of operation when the display exits the idle mode and enters the active mode.

The received indication can be of any suitable type. For example, the received indication can be a signal, such as a current or voltage signal. With reference to FIGS. 1A and 1B, for example, the on-board computing system 118 can receive a current signal, analyze the current signal to determine that the current signal corresponds to an instruction for activating a display of the HMD. As another example, the received indication can be an instruction for activating a display of the HMD. As yet another example, the received indication can be a value, and the receipt of the value by itself can serve as an indication to activate a display of the HMD. As still another example, the received indication can be an absence of a signal, value, instruction, or the like, and the absence can serve as an indication to activate a display of the HMD.

The indication to activate the display can be received from various devices or systems. In some implementations, the indication to activate the display can be received from a user interface. For example, with reference to FIGS. 1A and 1B, the on-board computing system 118 can receive an indication to activate a display of the HMD 102 from the finger-operable touch pad 124, after the touch pad 124 receives suitable user input. As another example, the on-board computing system 118 can receive the indication to activate the display of the HMD 102 in response to receiving or detecting a suitable voice command, hand gesture, or eye gaze, among other user gestures. In some implementations, the indication to activate the display can be received from a sensor without the need for user intervention.

Accordingly, at block 304, the method 300 includes receiving an indication to activate a display of an HMD when the display is in a low-power state of operation. In the method 300, blocks 306, 308, and 310 are performed in response to receiving the indication.

At block 306, the method 300 includes, before activating the display, obtaining a signal from an ambient light sensor that is associated with the HMD. For example, with reference to FIGS. 1A and 1B, the on-board computing system 118 can obtain a signal from the ambient light sensor 122 in various ways. As an example, the on-board computing system 118 can obtain a signal from the ambient light sensor 122 in a synchronous manner. For instance, the on-board computing system 118 can poll the ambient light sensor 122 or, in other words, continuously sample the status of the ambient light sensor 122 and receive signals from the ambient light sensor 122 as the signals are generated. As another example, the on-board computing system 118 can obtain a signal from the ambient light sensor 122 in an asynchronous manner. For instance, assume that the HMD 102 is switched off and that switching on the HMD 102 generates an interrupt input. When the on-board computing system 118 detects the generated interrupt input, the computing system 118 can begin execution of an interrupt service routine, in which the computing system 118 can obtain a signal from the ambient light sensor 122. These techniques are merely illustrative, and other techniques can be implemented for obtaining a signal from an ambient light sensor.

In the method 300, the signal from the ambient light sensor is indicative of ambient light at or near a time of receiving the indication. In some implementations, the signal can include a signal that is generated at the sensor and/or obtained from the sensor during a time period spanning from a predetermined time before receiving the indication up to and including the time of receiving the indication. As an example, with reference to FIGS. 1A and 1B, assume that the on-board computing system 118 receives signals from the ambient light sensor 122 in a synchronous manner by polling the ambient light sensor 122 at a predetermined polling frequency. Accordingly, the on-board computing system 118 receives signals from the ambient light sensor 122 at predetermined polling periods, each polling period being inversely related to the polling frequency. In this example, assume that the predetermined time period is three polling periods. In this example, in response to the on-board computing system 118 receiving the indication to activate the display, the computing system 118 can select any of the three signals that is generated and/or received at or prior to the time of receiving the indication. In other words, the computing system 118 can select a signal generated and/or received in a polling period that encompasses the time of receiving the indication, or can select a signal generated and/or received in one of the three polling periods that occurs prior to the time of receiving the indication. The selected signal can serve as the signal that is indicative of ambient light at or near a time of receiving the indication. In this example, the mention of three polling periods and three signals is merely for purposes of illustration; the predetermined time period can be any suitable duration and can span any suitable number of polling periods.

In some implementations, the signal can include a signal that is generated at the sensor and/or obtained from the sensor during a time period spanning from (and including) the time of receiving the indication to a predetermined time after receiving the indication. As in the previous example, assume that the on-board computing system 118 receives signals from the ambient light sensor 122 in a synchronous manner by polling the ambient light sensor 122 at a predetermined polling frequency. In the present example, assume that the predetermined time period is five polling periods. In this example, in response to the on-board computing system 118 receiving the indication to activate the display, the computing system 118 can select any of the five signals that is generated and/or received at or after the time of receiving the indication. In other words, the computing system 118 can select a signal generated and/or received in a polling period that encompasses the time of receiving the indication, or can select a signal generated and/or received in one of the five polling periods that occurs after the time of receiving the indication. The selected signal can serve as the signal that is indicative of ambient light at or near a time of receiving the indication. In this example, the mention of five polling periods and five signals is merely for purposes of illustration; the predetermined time period can be any suitable duration and can span any suitable number of polling periods.

In some implementations, the signal can include a signal that is generated at the sensor and/or obtained from the sensor during a time period spanning from a first predetermined time before receiving the indication to a second predetermined time after receiving the indication. As in the previous example, assume that the on-board computing system 118 receives signals from the ambient light sensor 122 in a synchronous manner by polling the ambient light sensor 122 at a predetermined polling frequency. In the present example, assume that the predetermined time period is two polling periods. In this example, in response to the on-board computing system 118 receiving the indication to activate the display, the computing system 118 can select any of the following signals: one of two signals that is generated and/or received during one of the two polling periods that occurs prior to the time of receiving the indication, a signal that is generated and/or received during a polling period that occurs at the time of receiving the indication, and one of two signals that is generated and/or received during one of the two polling periods that occurs after the time of receiving the indication. The selected signal can serve as the signal that is indicative of ambient light at or near a time of receiving the indication. In this example, the mention of two polling periods and five signals is merely for purposes of illustration; the predetermined time period can be any suitable duration and can span any suitable number of polling periods.

Although the previous three examples refer to obtaining one signal from an ambient light sensor, in some implementations, several signals can be obtained from the ambient light sensor. For example, with reference to FIGS. 1A and 1B, the on-board controller can obtain a first signal generated and/or received during a first polling period occurring prior to the time of receiving the indication, a second signal generated and/or received during a second polling period occurring during the time of receiving the indication, and a third signal generated and/or receiving during a third polling period occurring after the time of receiving the indication.

Some of the previous examples discuss obtaining a signal from an ambient light sensor by polling the ambient light sensor; however, the signal can be obtained in other ways, such as by using an asynchronous technique. As an example, with reference to FIGS. 1A and 1B, assume that the HMD 102 is switched off and that switching on the HMD 102 causes a generation of an interrupt input that represents the indication to activate the display of the HMD. When the on-board computing system 118 detects the generated interrupt input, the computing system 118 can begin execution of an interrupt service routine. In the interrupt service routine, the computing system 118 can cause the ambient light sensor 122 to sense ambient light and generate a signal that is indicative of the ambient light. In this way, the signal from the ambient light sensor can be generated in response to receiving the indication to activate the display of the HMD.

As mentioned above, in the method 300, the signal from the ambient light sensor is indicative of ambient light. The signal can be of various forms. For example, the signal can be a voltage or current signal, and the level of voltage or current can correspond to an amount of ambient light. As another example, the signal can be a signal that represents a binary value, and the binary value can indicate whether the amount of the ambient light exceeds a predetermined threshold. As yet another example, the signal can include encoded information that, when decoded by one or more processors (for example, the on-board computing system 118), enables the processor(s) to determine the amount of the ambient light. In addition to being indicative of ambient light, the signal can include other information. Examples of the other information include an absolute or relative time associated with the amount of the ambient light, header information identifying the ambient light sensor, and error detection and/or error correction information. These examples are illustrative; the signal from the ambient light sensor can be of various other forms and can include various other types of information.

At block 308, the method 300 includes determining a display-intensity value based on the signal. In the method 300, the display-intensity value is indicative of an intensity of one or more display-related devices or systems of the HMD. For example, the display-intensity value can include information that, by itself of when decoded, provides a luminous intensity of one or more projectors or other display-related devices of the HMD.

At block 310, the method 300 includes causing the display to switch from the low-power state of operation to a high-power state of operation. In the method 300, the intensity of the display upon switching is based on the display-intensity value. For example, with reference to FIGS. 1A and 1B, assume that display-intensity value has been determined. In response to switching a display of the HMD 102 from a low-power state of operation to a high-power state of operation, the on-board computing system 118 can cause the first projector 128 to project text, an image, a video, or any other type of projection onto an inside surface of the lens elements 112. Also, or instead, the computing system 118 can cause the second projector 132 to project a projection onto an inside surface of the lens element 110. Accordingly, in this example, the display constitutes one or both of the lens elements 110, 112. In this example, upon switching the display to the high-power state of operation, the computing system 118 projects the projection at an intensity that is based on the display-intensity value.

In the method 300, a mode of the display upon switching can be based on the signal from the ambient light sensor that is indicative of ambient light. As an example, with reference to FIGS. 1A and 1B, assume that the on-board computing device 118 obtains a signal from the ambient light sensor 122 and that the signal is indicative of a relatively low amount of ambient light. Accordingly, in this example, the HMD is located in a dark setting. The on-board computing device 118 can determine whether the amount of ambient light is sufficiently low, and if the computing device 118 so determines, then the computing device 118 can switch a display (for example, the lens elements 110, 112 functioning as the display) from a first mode to a second mode. In some implementations, in the second mode, a spectrum of light provided at the display is altered so that the spectrum includes one or more wavelengths in a target range and partially or entirely excludes wavelengths outside the target range. For example, in the second mode, a spectrum of light provided at the display can be altered so that the spectrum includes one or more wavelengths in the range of 620-750 nm and partially or entirely excludes wavelengths outside this range. Light that predominantly has one or more wavelengths in this range is generally discernible by the human eye as red or as a red-like color. Accordingly, in the second mode, the light provided at a display of an HMD can be altered so that the light has a red or red-like appearance to a user of the HMD. In some implementations, in the second mode, light is provided at the display at a low intensity. These examples are merely illustrative; in the second mode, light can be provided at a display of an HMD in various other ways.

In the method 300, the intensity and/or mode of the display can continue to be adjusted after the display is switched to the high-power state of operation. For example, with reference to FIGS. 1A and 1B, assume that the on-board computing system 118 has switched a display (for example, the lens elements 110, 112 functioning as the display) to the high-power state of operation. After doing so, the on-board computing system 118 can continue to obtain signals from the ambient light sensor 122 and to adjust the display's intensity and/or mode. In this way, the display's intensity and/or mode can be adjusted, continuously or otherwise at spaced time intervals, based on the ambient setting of the HMD 102.

### Example of a Configuration for Sensing Ambient Light

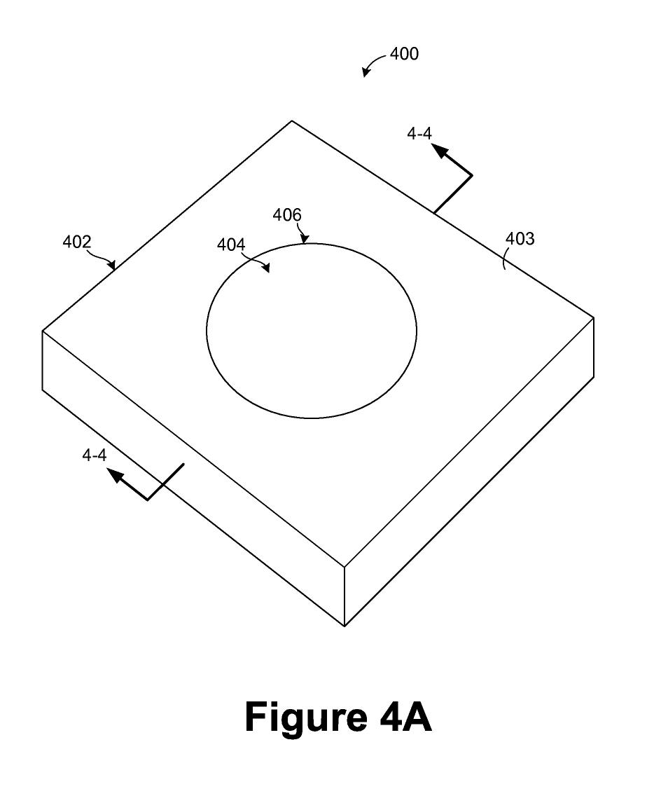

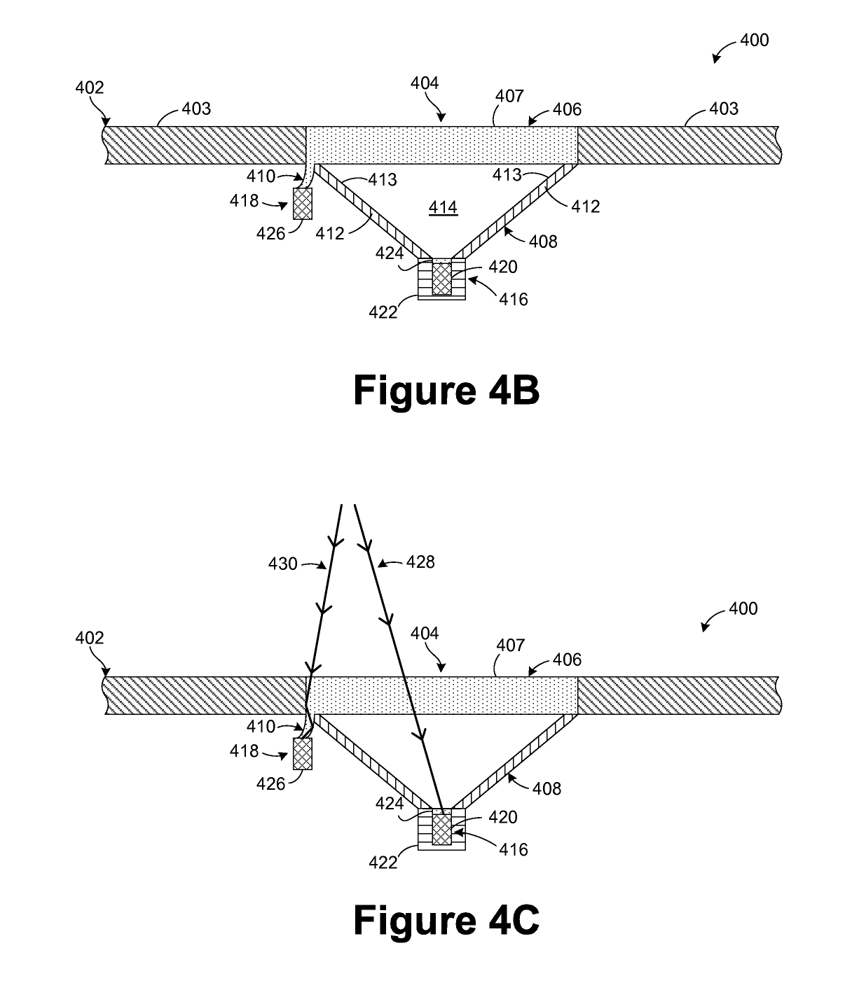

FIG. 4A shows a schematic illustration of a portion 400 of a wearable device according to a first embodiment. For example, the portion 400 can be provided in connection with the wearable device 100 (shown in FIGS. 1A and 1B), the wearable device 150 (shown in FIG. 1C), or the wearable device 170 (shown in FIG. 1D), among other types of wearable devices. As illustrated in FIG. 4A, the portion 400 includes a housing 402 and a light guide 404 that is disposed in the housing 402. At least a top surface 403 of the housing 402 is substantially opaque. A top portion 406 of the light guide 404 is substantially transparent. Accordingly, the top surface 403 of the housing 402 blocks light from entering the housing 402, and the top portion 406 of the light guide 404 functions as a contiguous optical opening that can permit light to pass into the light guide 404.

FIGS. 4B and 4C illustrate a cross-sectional view of the portion 400 of the wearable device, taken along section 4-4. As illustrated in FIG. 4B, the light guide 404 includes the top portion 406, a guide portion 408, and a channel portion 410.

The top portion 406 is substantially transparent. The top portion 406 can be formed of any suitable substantially transparent material or combination of materials. The top portion 406 can serve as a cover that can prevent dust and other particulate matter from reaching the inside of the light guide 404. The top portion 406 is configured to receive light, such as ambient light, at a top surface 407 and transmit a first portion of the light toward the guide portion 408 and transmit a second portion of the light toward the channel portion 410.

The guide portion 408 of the light guide 404 extends from the top portion 406 of the light guide 404. The guide portion 408 can be formed together with the top portion 406 as a single piece. The guide portion 408 can instead be a separate piece that is coupled to the top portion 406. In a variation, the guide portion 408 can extend from the housing 402. In this variation, the guide portion 408 can be formed together with the housing 402 as a single piece or can be a separate piece that is coupled to the housing 402. The guide portion 408 includes a radially extending wall 412 and a cavity 414 that is defined between the wall 412. The wall 412 extends radially inward as the wall 412 extends away from the top portion 406. The wall 412 includes an inner surface 413. The guide portion 408 is configured to receive light, such as ambient light, from the top portion 406 of the light guide 404 and to channel the light toward a first location 416. Accordingly, the inner surface 413 of the wall 412 can be substantially reflective so that the wall 412 can facilitate a transmission of the light toward the first location 416. The inner surface 413 of the wall 412 can be formed of any suitable substantially reflective material or combination of materials.

The channel portion 410 of the light guide 404 extends from the top portion 406 of the light guide 404. The channel portion 410 can be formed together with the top portion 406 as a single piece. The channel portion 410 can instead be a separate piece that is coupled to the top portion 406. The channel portion 410 is substantially transparent. The channel portion 410 can be formed of any suitable substantially transparent material or combination of materials. The channel portion 410 is configured to receive light, such as ambient light, from the top portion 406 and to transmit the light toward a second location 418. As shown in FIG. 4B, the channel portion 410 is curved. In some embodiments, the channel portion 410 is not curved.

An optical device 420 is disposed at the first location 416. In some embodiments, the optical device 420 includes a camera. The camera can be of any suitable type. For example, the camera can include a lens and a sensor, among other features. The sensor of the camera can be a charge-coupled device (CCD) or a complementary metal-oxide-semiconductor (CMOS), among other types of camera sensors. In some embodiments, the optical device 420 includes a flash device. The flash device can be of any suitable type. For example, the flash device can include one or more light-emitting diodes (LEDs). As another example, the flash device can include a flashtube. The flashtube can be, for example, a tube filled with xenon gas. Of course, the flash device can include a combination of different types of devices, such as a combination of LEDs and flashtubes. In some implementations, the optical device 420 includes a camera and a flash device. These embodiments and examples are merely illustrative, and the optical device 420 can include various other types of optical devices.

In the embodiment shown in FIG. 4B, the optical device 420 is disposed within a structure 422. The structure 422 extends from the wall 412 of the guide portion 408 of the light guide 404. The structure 422 can be formed together with the wall 412 as a single piece. The structure 422 can instead be a separate piece that is coupled to the wall 412. The structure 422 includes a substantially transparent plate 424 that separates the optical device 420 from the cavity 414 of the guide portion 408. The plate 424 can serve as a cover that can prevent dust and other particulate matter from reaching the optical device 420. Although FIG. 4B shows that the optical device 420 is disposed within the structure 422, in other embodiments, the optical device 420 may not be disposed in such a structure or can be disposed in a structure that has a different configuration.

A light sensor 426 is disposed at the second location 418. In some embodiments, the light sensor 426 is an ambient light sensor. The ambient light sensor can be configured to sense light, such as ambient light, and to generate a signal (or multiple signals) indicative of the sensed light. The ambient light sensor can have the same or similar functionality as the ambient light sensor 122 (shown in FIG. 1A), the ambient light sensor 162 (shown in FIG. 1C), or the ambient light sensor 182 (shown in FIG. 1D), among other ambient light sensors. The light sensor 426 can be disposed in a structure that is similar to the structure 422 or in a different structure, although this is not shown in FIG. 4B.

FIG. 4C shows the cross-sectional view of the portion 400 of the wearable device shown in FIG. 4B, with the addition of arrows to illustrate how the light guide 404 can direct light toward one or both of the optical device 420 and the light sensor 426. The light guide 404 defines a first aperture and a second aperture that each extends from a contiguous optical opening in the housing 402. In particular, the first aperture and the second aperture each extend from the substantially transparent top portion 406 that is disposed within the substantially opaque housing 402. The first aperture constitutes the substantially transparent top portion 406 of the light guide 404, the cavity 414 and substantially reflective wall 412 of the guide portion 408, and the substantially transparent plate 424 of the structure 422. The light guide 404 can direct a first portion of ambient light along a first path 428, for example, that passes through the first aperture toward the optical device 420 disposed at the first location 416. In addition, the second aperture constitutes the substantially transparent top portion 406 of the light guide 404 and the substantially transparent channel portion 410 of the light guide 404. The light guide 404 can direct a second portion of the ambient light along a second path 430, for example, that passes through the second aperture toward the light sensor 426 disposed at the second location 418. Accordingly, when ambient light is received at the top surface 407 of the top portion 406, which defines a contiguous optical opening in the housing 402, a first portion of the ambient light can be directed toward the optical device 420 and a second portion of the ambient light can be directed toward the light sensor 426.

For example, assume that the optical device 420 is a camera and that the light sensor 426 is an ambient light sensor. In this example, the camera and the ambient light sensor can each receive ambient light through the top portion 406 of the light guide 404. In this way, an optical device and a light sensor can receive ambient light without the need to provide multiple optical openings in a housing of a device.

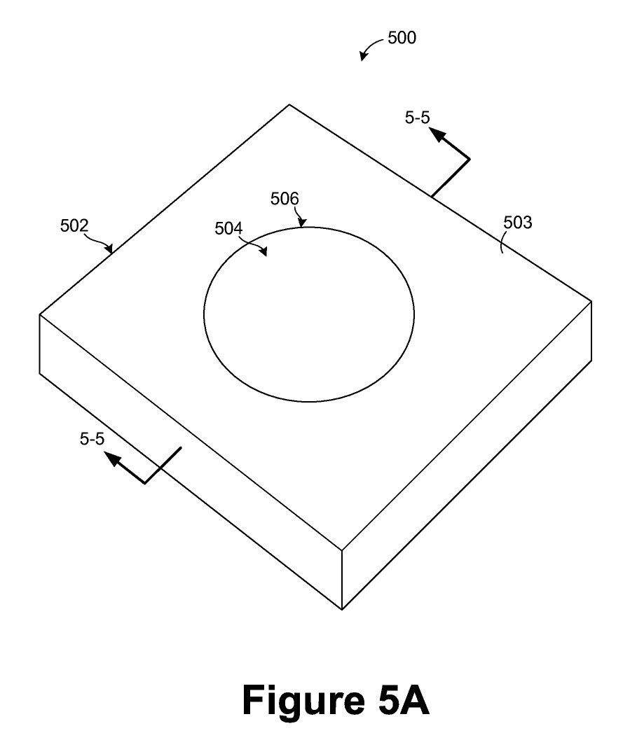

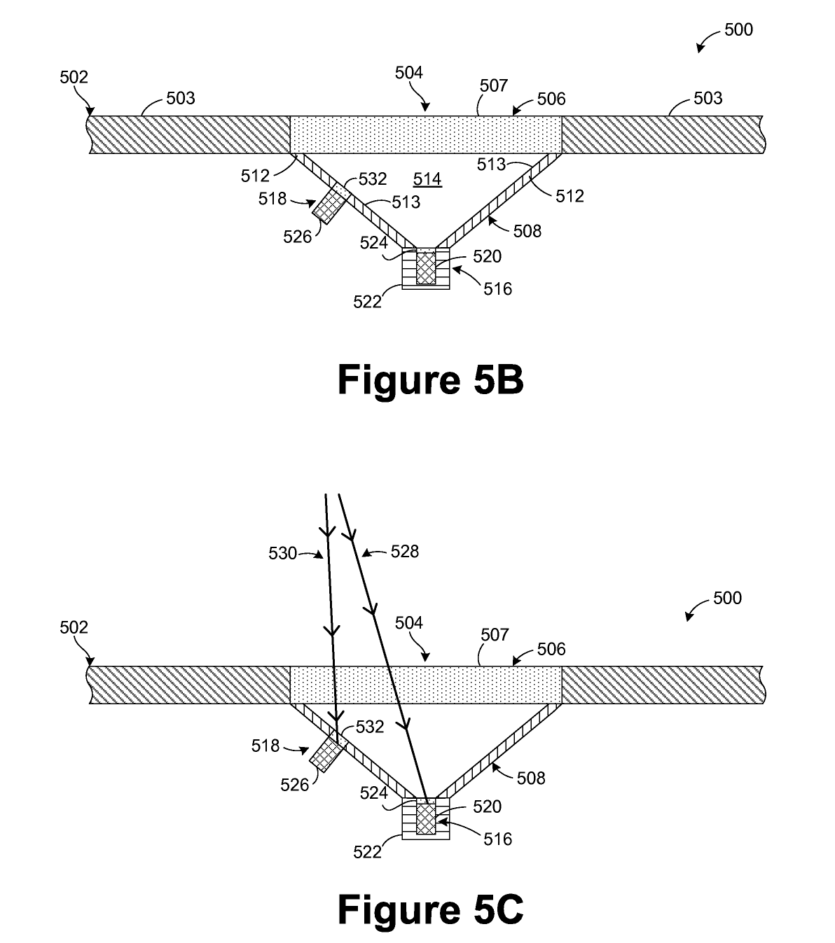

FIG. 5A shows a schematic illustration of a portion 500 of a wearable device according to a second embodiment. For example, the portion 500 can be provided in connection with the wearable device 100 (shown in FIGS. 1A and 1B), the wearable device 150 (shown in FIG. 1C), or the wearable device 170 (shown in FIG. 1D), among other types of wearable devices. Aside from the differences discussed below, the second embodiment is similar to the first embodiment, and accordingly, numerals of FIGS. 5A-5C are provided in a similar manner to corresponding numerals of FIGS. 4A-4C.

FIGS. 5B and 5C illustrate a cross-sectional view of the portion 500 of the wearable device, taken along section 5-5. In the second embodiment, the light guide 504 does not include a channel portion (such as the channel portion 410 shown in FIGS. 4A and 4B) that extends from the top portion 506. Instead, in the second embodiment, the guide portion 508 is provided with a substantially transparent portion 532 that is configured to direct light toward the light sensor 526 disposed at the second location 518. Note that the second location 518 is different from the second location 418 shown in FIGS. 4B-4C.

FIG. 5C shows the cross-sectional view of the portion 500 of the wearable device shown in FIG. 5B, with the addition of arrows to illustrate how the light guide 504 can direct light toward one or both of the optical device 520 and the light sensor 526. The light guide 504 defines a first aperture and a second aperture that each extends from a contiguous optical opening in the housing 502. In particular, the first aperture and the second aperture each extend from the substantially transparent top portion 506 that is disposed within the substantially opaque housing 502. The first aperture constitutes the substantially transparent top portion 506 of the light guide 504, the cavity 514 and substantially reflective wall 512 of the guide portion 508, and the substantially transparent plate 524 of the structure 522. The light guide 504 can direct a first portion of ambient light along a first path 528, for example, that passes through the first aperture toward the optical device 520 disposed at the first location 516. In addition, the second aperture constitutes the substantially transparent top portion 506 of the light guide 504 and the substantially transparent portion 532 of the guide portion 508. The light guide 504 can direct a second portion of the ambient light along a second path 530, for example, that passes through the second aperture toward the light sensor 526 disposed at the second location 518. Accordingly, when ambient light is received at the top surface 507 of the top portion 506, which defines a contiguous optical opening in the housing 502, a first portion of the ambient light can be directed toward the optical device 520 and a second portion of the ambient light can be directed toward the light sensor 526.

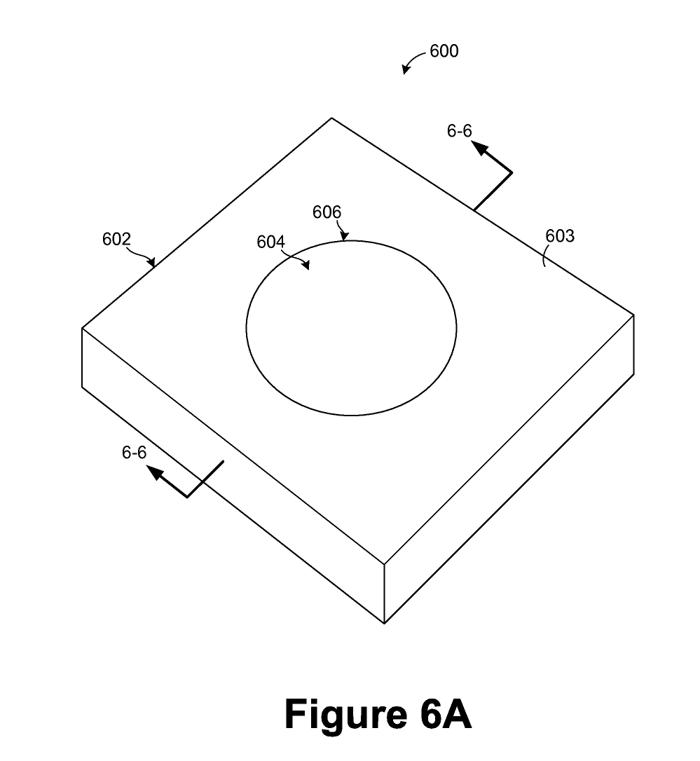

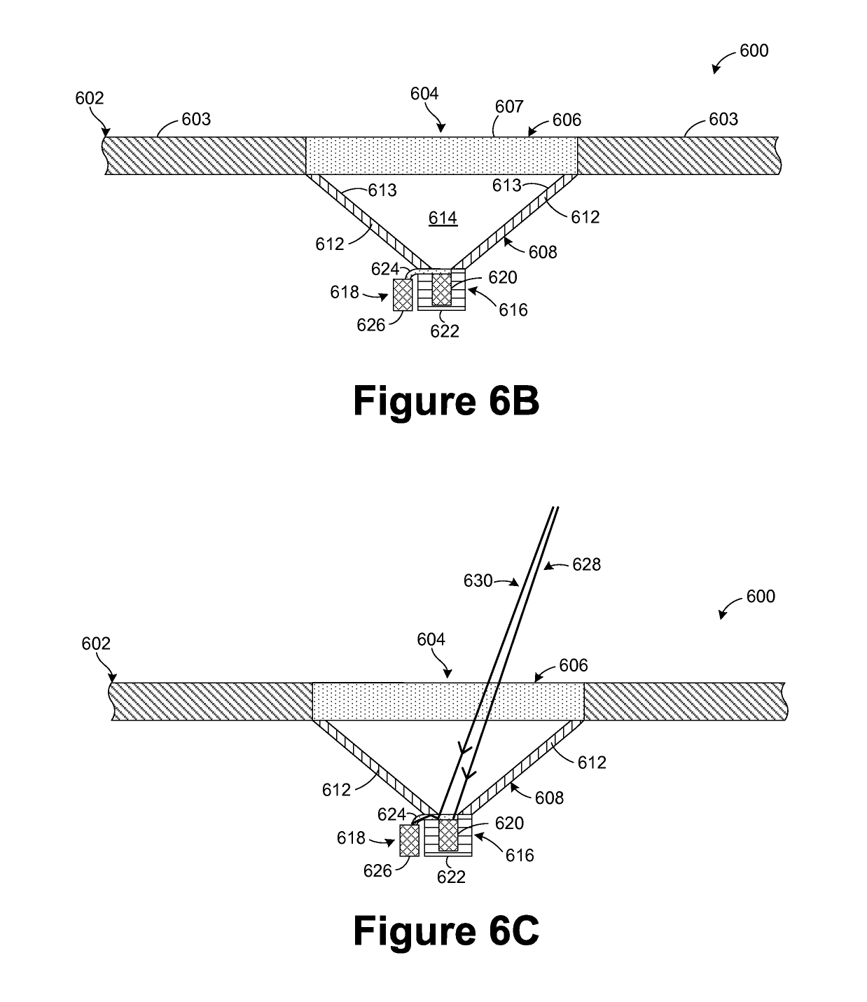

FIG. 6A shows a schematic illustration of a portion 600 of a wearable device according to a third embodiment. For example, the portion 600 can be provided in connection with the wearable device 100 (shown in FIGS. 1A and 1B), the wearable device 150 (shown in FIG. 1C), or the wearable device 170 (shown in FIG. 1D), among other types of wearable devices. Aside from the differences discussed below, the third embodiment is similar to the first embodiment, and accordingly, numerals of FIGS. 6A-6C are provided in a similar manner to corresponding numerals of FIGS. 4A-4C.

FIGS. 6B and 6C illustrate a cross-sectional view of the portion 600 of the wearable device, taken along section 6-6. In the third embodiment, the light guide 604 does not include a channel portion (such as the channel portion 410 shown in FIGS. 4A and 4B) that extends from the top portion 606. Instead, in the third embodiment, the substantially transparent plate 624 of the structure 622 extends outwardly and is configured to direct light toward the light sensor 626 disposed at the second location 618. Note that the second location 618 is different from the second location 418 shown in FIGS. 4B-4C and the second location 518 shown in FIGS. 5B-5C.

FIG. 6C shows the cross-sectional view of the portion 600 of the wearable device shown in FIG. 6B, with the addition of arrows to illustrate how the light guide 604 can direct light toward one or both of the optical device 620 and the light sensor 626. The light guide 604 defines a first aperture and a second aperture that each extends from a contiguous optical opening in the housing 602. In particular, the first aperture and the second aperture each extend from the substantially transparent top portion 606 that is disposed within the substantially opaque housing 602. The first aperture constitutes the substantially transparent top portion 606 of the light guide 604, the cavity 614 and substantially reflective wall 612 of the guide portion 608, and a first portion of the substantially transparent plate 624 of the structure 622. The light guide 604 can direct a first portion of ambient light along a first path 628, for example, that passes through the first aperture toward the optical device 620 disposed at the first location 616. In addition, the second aperture constitutes the substantially transparent top portion 606 of the light guide 604, the cavity 614 and substantially reflective wall 612 of the guide portion 608, and a second curved portion of the substantially transparent plate 624. The light guide 604 can direct a second portion of the ambient light along a second path 630, for example, that passes through the second aperture toward the light sensor 626 disposed at the second location 618. Accordingly, when ambient light is received at the top surface 607 of the top portion 606, which defines a contiguous optical opening in the housing 602, a first portion of the ambient light can be directed toward the optical device 620 and a second portion of the ambient light can be directed toward the light sensor 626.

In the discussion above, the first embodiment (shown in FIGS. 4A-4C), the second embodiment (shown in FIGS. 5A-5C), and the third embodiment (shown in FIGS. 6A-6C) include an optical device that is disposed near an end of a first aperture and a light sensor that is disposed near an end of a second aperture. However, in some embodiments, the optical device and the light sensor can be disposed near an end of the same aperture. For example, with reference to FIGS. 4A-4C, the light sensor 426 can be disposed in the structure 422 near the optical device 420 so that the light sensor 426 can receive light, such as ambient light, through the first aperture. For example, assume that the optical device 420 is a camera and that the light sensor 426 is an ambient light sensor. In this example, the camera and the ambient light sensor can both be disposed in the structure 422 and can both receive light from the first aperture. In this way, an optical device and a light sensor can receive ambient light through a single aperture that extends from a contiguous optical opening in a housing.

In addition, each of the first, second, and third embodiments is discussed above in reference to one light sensor (for example, the light sensor 426) and one optical device (for example, the optical device 420). However, these and other embodiments can include multiple light sensors and/or multiple optical devices.

In addition, the discussion above of the first, second, and third embodiments refers to some features as being “substantially transparent.” In some embodiments, corresponding features can be substantially transparent to electromagnetic waves having some wavelengths, and can be partially transparent to electromagnetic waves having other wavelengths. In some embodiments, corresponding features can be partially transparent to electromagnetic waves in the visible spectrum. These embodiments are merely illustrative; the transparency of the features discussed above can be adjusted according to the desired implementation.

In addition, the discussion above of the first, second, and third embodiments refers to some features as being “substantially opaque.” However, in some embodiments, corresponding features can be substantially opaque to electromagnetic waves having some wavelengths, and can be partially opaque to electromagnetic waves having other wavelengths. In some embodiments, corresponding features can be partially opaque to electromagnetic waves in the visible spectrum. These embodiments are merely illustrative; the opacity of the features discussed above can be adjusted according to the desired implementation.

### Example of a Method for Sensing Ambient Light

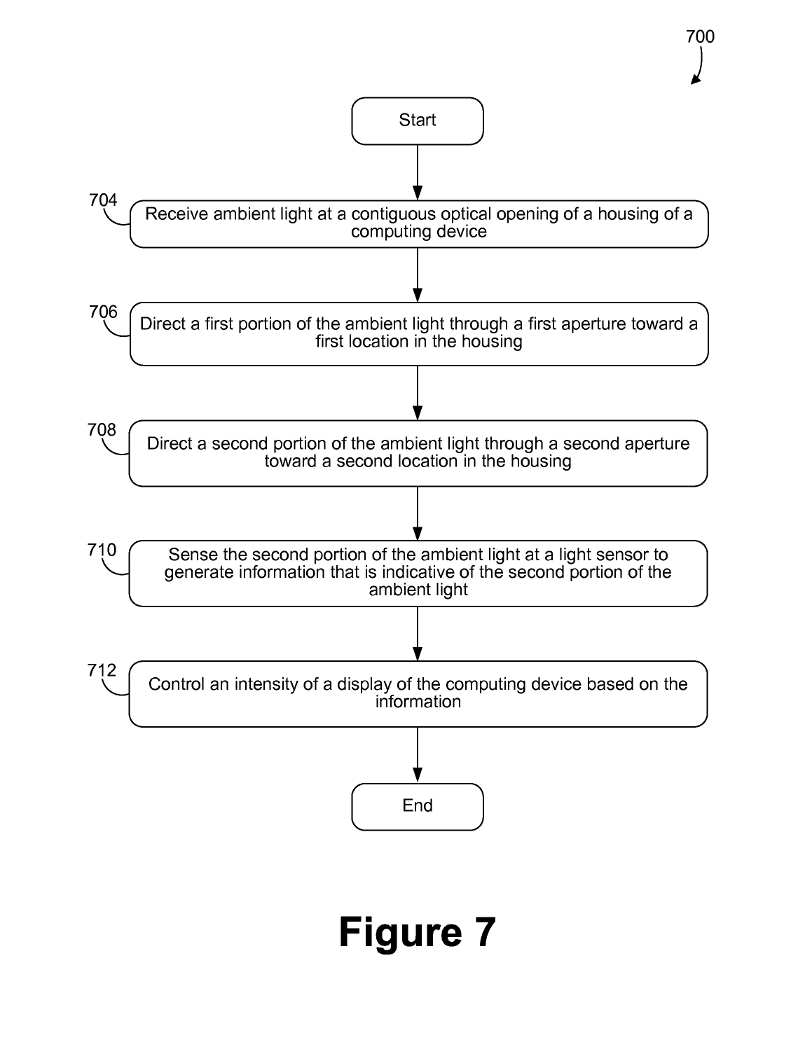

FIG. 7 illustrates an example of a method 700 for sensing ambient light. The method 700 can be performed, for example, in connection with the portion 400 of the wearable device shown in FIGS. 4A-4C, the portion 500 of the wearable device shown in FIGS. 5A-5C, or the portion of the wearable device shown in FIGS. 6A-6C. The method 700 can be performed in connection with another device, apparatus, or system.

At block 704, the method 700 includes receiving ambient light at a contiguous optical opening of a housing of a computing device. For example, with reference to the portion 400 of the wearable device shown in FIGS. 4A-4C, the substantially transparent top portion 406 of the light guide 404 can receive ambient light at the top surface 407 of the top portion 406. In the embodiment shown in FIGS. 4A-4C, the top portion 406 defines a contiguous optical opening in the housing 402.

At block 706, the method 700 includes directing a first portion of the ambient light through a first aperture toward a first location in the housing. For example, with reference to the portion 400 of the wearable device shown in FIGS. 4A-4C, the first portion of the ambient light can be directed through a first aperture toward the first location 416. In the embodiment shown in FIGS. 4A-4C, the first aperture constitutes the substantially transparent top portion 406 of the light guide 404, the cavity 414 and substantially reflective wall 412 of the guide portion 408, and the substantially transparent plate 424 of the structure 422.

At block 708, the method 700 includes directing a second portion of the ambient light through a second aperture toward a second location in the housing. For example, with reference to the portion 400 of the wearable device shown in FIGS. 4A-4C, the second portion of the ambient light can be directed through the second aperture toward the second location 418. In the embodiment shown in FIGS. 4A-4C, the second aperture constitutes the substantially transparent top portion 406 of the light guide 404 and the substantially transparent channel portion 410 of the light guide 404.

At block 710, the method 700 includes sensing the second portion of the ambient light at the light sensor to generate information that is indicative of the second portion of the ambient light. For example, with reference to the portion 400 of the wearable device shown in FIGS. 4A-4C, the light sensor 426 can sense the second portion of the ambient light to generate information that is indicative of the second portion of the ambient light.

At block 712, the method 700 includes controlling an intensity of a display of the computing device based on the information. For example, with reference to the portion 400 of the wearable device shown in FIGS. 4A-4C, a controller (not shown in FIGS. 4A-4C) can control an intensity of a display of a wearable device based on information generated at the light sensor 426. The controller can be, for example, the on-board computing system 118 (shown in FIG. 1A), the on-board computing system 154 (shown in FIG. 1C), the computing device 200 (shown in FIG. 2), or another type of computing device or system.

The method 700 can include using the first portion of the ambient light at the optical device to capture an image. For example, the optical device can include a camera that includes, among other features, a lens and a sensor. The camera sensor can be of various types, such as, for example, a charge-coupled device (CCD) or a complementary metal-oxide-semiconductor (CMOS), among other types of camera sensors. Accordingly, the camera can use the first portion of the ambient light to capture an image.

### CONCLUSION

With respect to any or all of the ladder diagrams, scenarios, and flow charts in the figures and as discussed herein, each block and/or communication can represent a processing of information and/or a transmission of information in accordance with disclosed examples. More or fewer blocks and/or functions can be used with any of the disclosed ladder diagrams, scenarios, and flow charts, and these ladder diagrams, scenarios, and flow charts can be combined with one another, in part or in whole.

A block that represents a processing of information can correspond to circuitry that can be configured to perform the specific logical functions of a herein-described method or technique. Alternatively or additionally, a block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk or hard drive or other storage medium.

The computer readable medium can also include non-transitory computer readable media such as computer-readable media that stores data for short periods of time like register memory, processor cache, and random access memory (RAM). The computer readable media can also include non-transitory computer readable media that stores program code and/or data for longer periods of time, such as secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a block that represents one or more information transmissions can correspond to information transmissions between software and/or hardware modules in the same physical device. However, other information transmissions can be between software modules and/or hardware modules in different physical devices.

While various examples and embodiments have been disclosed, other examples and embodiments will be apparent to those skilled in the art. The various disclosed examples and embodiments are for purposes of illustration and are not intended to be limiting, with the true scope and spirit being indicated by the following claims.

What is claimed is:

1. A computer-implemented method comprising:
when a display of a head-mountable display (HMD) is in a low-power state of operation, receiving an indication to activate the display; and
in response to receiving the indication:
before activating the display, obtaining a signal from an ambient light sensor that is associated with the HMD, wherein the signal is indicative of ambient light at or near a time of receiving the indication;
determining a display-intensity value based on the signal; and
causing the display to switch from the low-power state of operation to a high-power state of operation, wherein an intensity of the display upon switching is based on the display-intensity value.

2. The method of claim 1, wherein the signal from the ambient light sensor is generated in response to receiving the indication.

3. The method of claim 1, wherein the signal from the ambient light sensor is generated prior to receiving the indication.

4. The method of claim 1, further comprising causing the display to switch from a first mode to a second mode based on the signal, wherein in the second mode, a spectrum of light provided at the display is altered such that the spectrum includes one or more wavelengths in a target range.

5. The method of claim 4, wherein causing the display to switch from the first mode to the second mode occurs in response to causing the display to switch from the low-power state of operation to the high-power state of operation.

6. A system comprising:
a non-transitory computer-readable medium; and
program instructions stored on the non-transitory computer-readable medium and executable by at least one processor to:
when a display of a head-mountable display (HMD) is in a low-power state of operation, receive an indication to activate the display; and
in response to receiving the indication:
before activating the display, obtain a signal from an ambient light sensor that is associated with the HMD, wherein the signal is indicative of ambient light at or near a time of receiving the indication;
determine a display-intensity value based on the signal; and
cause the display to switch from the low-power state of operation to a high-power state of operation, wherein an intensity of the display upon switching is based on the display-intensity value.

7. The system of claim 6, wherein the signal from the ambient light sensor is generated in response to receiving the indication.

8. The system of claim 6, wherein the signal from the ambient light sensor is generated prior to receiving the indication.

9. The system of claim 6, wherein a mode of the display upon switching is based on the signal.

10. A computing device comprising:
a light guide disposed in a housing of the computing device, the light guide having a substantially transparent top portion, wherein the light guide is configured to receive ambient light through the top portion, to direct a first portion of the ambient light along a first path toward an optical device disposed at a first location, and to direct a second portion of the ambient light along a second path toward a light sensor disposed at a second location;
the light sensor, wherein the light sensor is configured to sense the second portion of the ambient light and to generate information that is indicative of the second portion of the ambient light; and
a controller configured to control an intensity of the display based on the information.

11. The computing device of claim 10, wherein the transparent top portion defines a contiguous optical opening in the housing.

12. The computing device of claim 10, wherein:
the light guide includes a channel that extends from the top portion of the light guide toward the second location;
the light guide is configured to direct the first portion of the ambient light through the top portion toward the optical device; and
the light guide is configured to direct the second portion of the ambient light through the channel toward the light sensor.

13. The computing device of claim 10, wherein the optical device includes a camera.

14. The computing device of claim 10, wherein the optical device includes a flash device.

15. The computing device of claim 10, wherein:
the light guide includes a guide portion that extends from the top portion of the light guide toward the first location;
the guide portion includes a substantially opaque region and a substantially transparent region, wherein the substantially transparent region is disposed proximate to the second location;
the light guide is configured to direct the first portion of the ambient light along the substantially opaque region toward the optical device; and
the light guide is further configured to direct the second portion of the ambient light through the substantially transparent region toward the light sensor.

16. The computing device of claim 10, wherein:
the light guide includes a curved portion that extends toward the second location; and
the light guide is configured to direct the second portion of the ambient light through the curved portion toward the light sensor.

17. The computing device of claim 10, wherein the curved portion extends from the top portion of the light guide.

18. The computing device of claim 10, wherein the housing and the light guide are formed together.

19. The computing device of claim 10, wherein the computing device is a head-mountable display.

20. A method comprising:
receiving ambient light at a contiguous optical opening of a housing of a computing device;
directing a first portion of the ambient light through a first aperture toward a first location in the housing, wherein an optical device is disposed at the first location;
directing a second portion of the ambient light through a second aperture toward a second location in the housing, wherein a light sensor is disposed at the second location;
sensing the second portion of the ambient light at the light sensor to generate information that is indicative of the second portion of the ambient light; and
controlling an intensity of a display of the computing device based on the information.

21. The method of claim 20, comprising using the first portion of the ambient light at the optical device to capture an image.
